(19) United States
(12) Patent Application Publication
(10) Pub. No.: US 2025/0198927 A1
(43) Pub. Date: Jun. 19, 2025

(54) METHOD AND DEVICE FOR THE MARKER-FREE DETECTION OF AN ANALYTE

(71) Applicant: FLUIDECT GMBH, Jena (DE)

(72) Inventors: Tobias SCHRÖTER, Jena (DE); Michael HIMMELHAUS, Bürgel (DE)

(73) Assignee: FLUIDECT GMBH, Jena (DE)

(21) Appl. No.: 18/846,966

(22) PCT Filed: Mar. 16, 2023
(86) PCT No.: PCT/DE2023/000018

§ 371 Date: Sep. 13, 2024

(30) Foreign Application Priority Data
Mar. 16, 2022 (DE) 10 2022 001 000.3

(51) Int. Cl. G01N 21/64; G01N 21/77

(52) U.S. Cl. CPC G01N 21/645; G01N 21/77; G01N 2021/6417; G01N 2021/6482; G01N 2021/7786; G01N 2021/7789

(57) ABSTRACT

Disclosed are a method and a device for the marker-free detection of an analyte in a fluid. At least one dielectric microsensor is used, which comprises a microresonator and an adsorbate layer for binding an analyte, which adsorbate layer is applied to the microresonator. The microresonator consists of a particle which comprises a dielectric material and a fluorescent marker. Furthermore, the microresonator has an optical refractive index that is higher than the optical refractive index of a fluid to be analyzed. The microresonator is suitable for allowing more than one resonance mode to form in the interior thereof when the fluorescent marker is excited. The optical thickness of the adsorbate layer of the microsensor is determined from spectral positions of at least two detected optical resonance modes of the microsensor and used to determine the extent to which an analyte has bonded to the at least one microsensor.

A method and a device for the label-free detection of an analyte in a fluid is presented. At least one dielectric microsensor is used, which has a microresonator and an adsorbate layer applied to the microresonator for binding an analyte. The microresonator consists of a particle that has a dielectric material and a fluorescent marker. Furthermore, the microresonator has a higher optical refractive index than the optical refractive index of a fluid to be analyzed. The microresonator is suitable for allowing more than one resonance mode to be formed when the fluorescent marker is excited in its interior. An optical thickness of the adsorbate layer of the microsensor is determined from the spectral positions of at least two detected optical resonance modes of the microsensor and the extent to which an analyte has bound to the at least one microsensor is determined from this.

Whispering Gallery Mode (WGM) based sensors are suitable for determining the physical, chemical and/or biochemical parameters of a fluid. A fluorescent microparticle of a few micrometers in diameter is used as a microscopic optical sensor. Microparticles and their surface can be conditioned accordingly to fulfil the specific task in question, for example by specifically functionalizing their surface by means of an applied biochemical layer (M. Himmelhaus, Microsensors on the Fly, Optik & Photonik, 2016, Vol. 11, pages 43-47).

If the fluorescence in the microparticle is excited, the dye emits light at a longer wavelength compared to the excitation. Since this light is emitted in any spatial direction, it can also incidentally hit the microparticle wall under grazing incidence and undergo total reflection within the microparticle (i.e. in an interior space of the microparticle), provided that the refractive index of the microparticle is greater than that of the surrounding medium. Depending on its diameter, the microparticle represents an optical cavity of specific size, which can be filled by individual wavelengths of the spectrally broadband fluorescence spectrum in the form of resonance modes. The spectrum emitted to the outside by the microparticle is characterized by these characteristic modes.

If the optical diameter of the microparticle changes, for example due to the binding (or attachment) of a substance to be analyzed (i.e. an analyte) to its outer surface, the characteristic spectrum of the microparticle also changes. Spectral analysis can be used to analyze the characteristic spectrum of the microparticle, which allows conclusions to be drawn about the optically effective diameter of the microparticle and thus indirectly about the surface coverage with analyte. A microparticle suitable for this procedure is also referred to below as a “microresonator”.

A microresonator can be coated with an adsorbate layer that is physically and/or chemically applied to the surface of the microresonator or attached to it and has a function appropriate to the respective application of the microresonator. For example, if the microresonator is used as a biosensor, this can be an adsorbate layer (e.g. an organic layer) that is suitable for specifically binding a certain analyte. The adsorbate layer is usually chemically different from the material of the microresonator and can therefore have a different optical refractive index from the base material of the microresonator. The microresonator together with its adsorbate layer can also be referred to as a “microsensor”.

When biological materials (such as proteins, antibodies, peptides, oligonucleotides, DNA, RNA, viruses, bacteria and/or their components) are attached to the surface of the microsensor, the optical diameter of the microsensor typically only changes by a few nanometers, i.e. very little compared to the overall diameter of the microsensor (which is usually several micrometers). The manufacturing-related diameter tolerances of microresonators alone are in the order of at least 50 nm (typical standard deviation of commercially available microparticles: 1-5%) and are therefore already significantly greater than the changes to be expected due to the adsorption of biomolecules.

For this reason, in previously known methods for quantifying the surface coverage of the respective microresonator, the spectrum determined after adsorption always had to be referenced to a spectrum from the same microresonator before adsorption, i.e. the microresonator had to be measured at least once before and once after binding of the analyte (see e.g. WO 02/13337 A1, WO 2005/116615 A1, Foreman et al., Advances in Optics and Photonics, 2015, Vol. 7, pages 168-240).

This necessity in the known prior art methods is time-consuming, uneconomical and severely limits the applicability of WGM-based microscopic sensors. The need for multiple measurements of one and the same microresonator means, among other things, that it must be detectable several times during the measurement process. Previous methods therefore use immobilized microsensors that are, for example, adsorbed onto rigid surfaces, adsorbed onto biological cells or held in microstructures.

There is therefore a desire to enable a measurement method in which a microsensor can move freely in the medium to be examined, as the measurement method can thus be carried out faster and more economically and a more comprehensive analysis is possible. However, this is not possible with the methods known in the prior art for quantifying surface coverage due to the immobilization of the microsensor. Furthermore, due to the immobilization of the microsensor in the prior art methods, no continuous (i.e. continuous) measurements are possible, i.e. it is not possible to quasi-continuously and fully scan a fluid with a potential analyte. Consequently, existing implementations of WGM-based microsensor technology have so far only been suitable for certain laboratory systems, but not for applications in the field of continuous process monitoring. An example of a laboratory system that stands out from other state-of-the-art systems through the use of microfluidic channels with integrated holding structures was presented by Bischler et al. (R. Bischler et al., Eur. Phys. J. Special Topics, 2014, Vol. 223, pages 2041-2055 and DE 10 2014 104 595 A1). Here, the microsensors are only temporarily fixed in position by the holding structures and can be repeatedly moved into the measuring position by an automated mechanical displacement unit. Once the measurement is complete, the microfluidic channel can be cleaned and refilled. The significance of the measurement result can be increased by successively moving several microsensors during the measurement. Nevertheless, the system is not suitable for use in continuous process monitoring, as both the volume flow through the microfluidic channel and the number of microsensors that can be used per measurement are limited and are far below the requirements for continuous process monitoring. In addition, relative shifts in the resonance modes are also used here, as is usual with state-of-the-art technology, to draw conclusions about surface coverage, so that multiple measurements of one and the same microsensor are absolutely essential.

However, the lack of suitability of label-free biosensors for use in the field of continuous process monitoring does not only apply to previous implementations of WGM-based microsensor technology, but is also a shortcoming that affects other common methods for the label-free detection of biological species, such as surface plasmon resonance (SPR), quartz microbalance (QMC) and/or ellipsometry. In all of these methods, the sensor surface that reacts specifically with the analyte is usually formed as a wall in a microchannel. The sensor surface can be supplied with the analyte and the media required for conditioning the surface through the microchannel. However, as generally laminar flows form in microchannels, this means that the flow at the sensor surface is virtually stationary and the transport of the analyte to the sensor surface is therefore diffusion-limited. This not only results in long measurement times, but also in distorted (i.e. incorrect) binding kinetics if the diffusion zone is depleted, and thus an erroneous determination of the affinity and avidity of the analyte under investigation to its binding partner.

An attempt to overcome this shortcoming of existing implementations for a WGM-based microsensor system is described in U.S. Pat. No. 8,779,389 B2. In the method disclosed there, the microparticles flow freely with the medium to be analyzed and are read out randomly when they are detected by the optical system. It can be assumed that each microparticle is measured only once, so that the required referencing cannot be performed on the same microparticle, but must be accomplished in another way. For this purpose, U.S. Pat. No. 8,779,389 B2 suggests comparing the one characteristic spectrum of the microparticle detected in each case with a set of suitably predetermined characteristic spectra and using this comparison to determine a best-fitting predetermined spectrum. Analytes adsorbed on the microparticle are detected via deviations of the measured spectrum from the best-fitting predetermined spectrum. How a best-fit predetermined spectrum can be determined without an additional measured reference (e.g. before interaction of the microparticle with the analyte), when it deviates from the measured spectrum in the presence of the analyte, is not described in more detail. In addition, the refractive index of the medium can be determined in advance and compared with that from the measurement with reference to the best-fitting spectrum. To determine the refractive index of the medium, an amount of microparticles sufficient for a statistical evaluation is measured in advance in the selected medium in the absence of the analyte in order to obtain a statistical reference from which the refractive index of the medium can be determined. Deviations from the reference value are also evaluated here as an indication of the presence of the analyte in the medium. In each of its embodiments, the method thus only provides qualitative information about the presence of an analyte in the medium under investigation in the sense of a “yes/no sensor” and therefore does not meet the requirements for quantitative biosensor technology explained above, which also allows, for example, the measurement of binding kinetics and, derived from this, the determination of affinities and avidities. In contrast, the method of the present invention determines an optical thickness of an adsorbate layer on the microresonator, which also includes the potential analyte. This optical thickness of an adsorbate layer is determined independently of the refractive index of the medium and provides a quantitative measure of the surface coverage of the microresonator, which also allows quantitative statements to be made about the concentration of the analyte in the medium and the measurement of binding kinetics.

Based on this, it was the endeavor of the present invention to provide a method and an apparatus which do not have the disadvantages known in the prior art. In particular, it should be possible with the method and the device to quantitatively detect an analyte in a sample without labeling, quickly, economically and in a continuous manner and without risk of falsified results, whereby it should also be possible to detect unadulterated (i.e. correct) binding kinetics of the analyte to a target molecule.

The problem is solved by the method with the features of claim 1 and the device with the features of claim 8. The dependent claims show advantageous further embodiments.

According to the invention, there is provided a method for the label-free detection of an analyte in a fluid, comprising the steps of (or consisting of)
a) Providing at least one dielectric microsensor in a container, the at least one microsensor comprising or consisting of a microresonator and an adsorbate layer applied to the microresonator for binding an analyte, wherein the microresonator consists of a particle comprising or consisting of a dielectric material and a fluorescent marker, the microresonator having a greater optical refractive index than the optical refractive index of a fluid to be analyzed, the microresonator being suitable for allowing more than one resonance mode to be expressed in an interior of the microresonator when a fluorescence of the fluorescence marker is excited;
b) Contacting the at least one microsensor with a fluid to be analyzed that could contain an analyte;
c) irradiating light onto the at least one microsensor in the fluid, the light having a wavelength suitable for exciting the fluorescent marker of the at least one microsensor to fluoresce;
d) Detection of at least two optical resonance modes of the at least one microsensor from a detected fluorescent light of the at least one microsensor;
e) determination of an optical thickness of the adsorbate layer of the at least one microsensor in the fluid from spectral positions of the at least two detected resonant modes via numerical algorithms; and
f) Determination, based on the previously determined optical thickness of the adsorbate layer of the at least one microsensor, of the extent to which an analyte in the fluid has bound to the at least one microsensor.

The method according to the invention provides for detecting at least two emitted modes (i.e. more than one emitted mode) of the microsensor. The absolute thickness of the adsorbate layer can then be determined on the basis of the position of the detected modes relative to one another. If the thickness of the adsorbate layer obtained in this way is compared with the known thickness of the adsorbate layer applied to the microresonator during the manufacturing process, it is possible to draw qualitative conclusions without any falsifying influence as to the degree to which an analyte has bound (or attached) to the surface of the microsensor, i.e. the degree to which an analyte in the fluid has bound to the microsensor. With the determination of absolute thicknesses of adsorbate layers from individual measurements on the microsensors, the method according to the invention relates to a general measurand that can be determined under a wide variety of process conditions. Consequently, the method according to the invention is suitable for use under constantly changing process conditions and also for continuous (i.e. continuous) process monitoring. Since the requirement of maintaining identical process conditions as in prior art methods becomes obsolete, the method according to the invention can also be carried out more easily, more quickly, more economically and with less equipment.

According to the invention, the term “fluorescent marker” also refers in particular to quantum dots.

In the process, the particle of the microresonator can have a diameter in the range from 1 μm to 20 μm, preferably 2 μm to 15 μm, particularly preferably 4 μm to 10 μm.

Furthermore, the adsorbate layer can have a thickness in the range from 0.5 nm to 30 nm, preferably 1 nm to 20 nm, particularly preferably 1.5 nm to 10 nm, especially 2 nm to 8 nm, whereby the thickness is understood to be a spatial expansion of the adsorbate layer in the radial direction from a center point of the microresonator. In the case of very thin adsorbate layers in the range of a few nanometers (e.g. thickness≤2 nm), the separation of optical refractive index and geometric layer thickness can no longer be made reliably. The primary result of determining the optical thickness of the adsorbate layer of the at least one microsensor is then a so-called “optical layer thickness”, i.e. a product of the type n_{Ads}*d_{Ads}, where n_{Ads} represents the optical refractive index of the adsorbate layer and d_{Ads} its thickness in the radial direction. This definition is comparable to the optical path length known from optics, which in turn represents a product of optical refractive index and geometric path length. For the purposes of the present invention, knowledge of the optical path length is sufficient, since it changes with the adsorption of an analyte onto the adsorbate layer, even if the geometric path length changes only slightly, for example due to diffusion of the analyte or its exchange with previously non-specifically bound molecules. In addition, the optical refractive indices of most materials that are relevant for the structure of the adsorbate layer (e.g. biomolecules) are very similar to the optical refractive indices of the analyte to be bound. The optical refractive indices are typically in the range of 1.43 to 1.48.

In the method, there is preferably no step of determining an optical thickness of the adsorbate layer of the at least one microsensor before step b). This embodiment allows the method to be carried out more quickly and economically.

The optical thickness of the adsorbate layer can be determined in the method according to a rigorous classical field theory.

In the method, the optical thickness of the adsorbate layer can be determined from spectral positions of the at least two detected resonant modes and at least one further parameter selected from the group consisting of relative amplitudes of the at least two detected resonant modes and line widths of the at least two detected resonant modes, using numerical algorithms. This embodiment has the advantage that the optical thickness of the adsorbate layer can be determined even more accurately. By using a microresonator that is suitable for allowing more than one resonance mode to be expressed in an interior of the microresonator when a fluorescence of the fluorescence marker is excited, it is possible for a line width of the individual modes to be smaller than their spectral spacing, so that the modes can be separated spectrally.

Furthermore, in the method, a further parameter of the at least one microsensor can be determined from spectral positions of the at least two detected resonance modes, and preferably from at least one further parameter selected from the group consisting of relative amplitudes of the at least two detected resonance modes and line widths of the at least two detected resonance modes, using numerical algorithms. The further parameter is preferably selected from the group consisting of the diameter of the at least one microsensor, the refractive index of the at least one microsensor, the refractive index of the adsorbate layer of the at least one microsensor and combinations thereof.

Apart from this, a parameter of the fluid can be determined in the method from spectral positions of the at least two detected resonance modes, and preferably from at least one further parameter selected from the group consisting of relative amplitudes of the at least two detected resonance modes and line widths of the at least two detected resonance modes, using numerical algorithms, preferably an optical property of the fluid can be determined.

The at least one microsensor used in the method can be designed as an essentially spherical particle. This is advantageous because the property of the microresonator of the microsensor to form resonant modes depends on the shape of the microresonator. Due to their high symmetry, spherical particles form resonance modes independent of the respective propagation plane within the particle, which facilitates their detection, especially for particles moving freely in a fluid. Particles that are very strongly aspherical (e.g. irregularly shaped, i.e. without an axis of symmetry) do not show any observable resonance modes because light is scattered out of the particles too quickly. The lifetimes of the resonance modes for such particles are therefore so short that the line widths overlap and are therefore no longer observable.

The fluorescent marker of the microresonator can be arranged in an inner space of the microresonator or on an outer surface of the microresonator.

The detection of at least two optical resonance modes of the at least one microsensor can be performed by detecting light that is scattered by the at least one microsensor and/or emitted by the at least one microsensor.

The at least one microsensor used in the method can be freely movable. This is preferred, as the method can thus be carried out more quickly and economically. Alternatively, the at least one microsensor can be fixed, in particular fixed to an inner surface of a fluid channel in which the contact of the at least one microsensor with a fluid to be analyzed, which could contain an analyte, takes place.

In the method, the detection of at least two optical resonance modes of the at least one microsensor can be repeated at least once, optionally several times, in order to determine a time course of the optical thickness of the adsorbate layer of the at least one microsensor from spectral positions of the at least two detected resonance modes, and preferably from at least one further parameter selected from the group consisting of relative amplitudes of the at least two detected resonance modes and line widths of the at least two detected resonance modes, using numerical algorithms. This embodiment has the advantage that the binding kinetics of an analyte to the microsensor can be detected. In contrast to prior art methods that use immobilized microsensors, the determination of the binding kinetics using the method according to the invention is not subject to errors. In addition to the binding kinetics itself, it is also possible to determine whether it has already reached a static state. From the quantification of the quantity of adsorbed analytes in the static state, it is thus possible to draw conclusions about their content in the fluid under investigation in an even more precise and less error-prone manner.

In the method, a time course of at least one further parameter of the at least one microsensor can also be determined from spectral positions of the at least two detected resonance modes, and preferably from at least one further parameter selected from the group consisting of relative amplitudes of the at least two detected resonance modes and line widths of the at least two detected resonance modes, using numerical algorithms. The at least one further parameter can be selected from the group consisting of the diameter of the at least one microsensor, the refractive index of the at least one microsensor, the refractive index of the adsorbate layer of the at least one microsensor, the refractive index of the fluid and combinations thereof. The advantage of this embodiment is that a time course of other parameters of the at least one microsensor or the fluid of the analyte can also be recorded.

According to the invention, there is further provided a device for the label-free detection of an analyte in a fluid, comprising (or consisting of)
a) a container containing at least one dielectric microsensor, the at least one microsensor comprising or consisting of a microresonator and an adsorbate layer applied to the microresonator for binding an analyte, wherein the microresonator consists of a particle containing or consisting of a dielectric material and a fluorescent marker, the microresonator having a greater optical refractive index than the optical refractive index of a fluid to be analyzed, the microresonator being suitable for allowing more than one resonance mode to be expressed in an interior of the microresonator when a fluorescence of the fluorescence marker is excited;
b) a light source for irradiating light onto the at least one microsensor, the light having a wavelength which is suitable for exciting the fluorescent marker of the at least one microsensor to fluoresce,
c) a spectral analysis unit configured to detect at least two optical resonance modes of the at least one microsensor from a detected fluorescent light;
d) an algorithmic unit configured to determine an optical thickness of the adsorbate layer of the at least one microsensor from spectral positions of the at least two detected resonant modes via numerical algorithms; and
e) an analysis unit which is configured to determine, based on the determined optical thickness of the adsorbate layer of the at least one microsensor, the extent to which an analyte has bound to the at least one microsensor.

The device according to the invention can be used to draw qualitative and even quantitative conclusions, without any falsifying influence, about the degree to which an analyte has bound (or adsorbed) to the surface of the microsensor, i.e. the degree to which an analyte in the fluid has bound to the microsensor. Since the device enables the determination of absolute thicknesses of adsorbate layers from individual measurements on the microsensors, the analyte can be determined under a wide range of process conditions. Consequently, the device according to the invention is suitable for use under constantly changing process conditions and also for continuous (i.e. continuous) process monitoring. Since the requirement of maintaining identical process conditions as with prior art devices becomes obsolete, the detection of the analyte by the device according to the invention can also be carried out more easily, faster, more economically and with less equipment.

The device according to the invention also allows the detection of binding of an analyte to a non-immobilized (i.e. freely movable) microsensor. Consequently, the device according to the invention does not require, for example, a movable stage, which would otherwise be necessary for fixing and specifically positioning the microsensors above a detection unit in prior art devices. This eliminates the need for costly mechanical positioning axes and, for example, an air gap between the detection optics and the microstructure holding the microsensors. By eliminating the air gap, immersion objectives with numerical apertures above 1.0 (theoretical limit for air gap objectives) can be used so that a higher proportion of the fluorescence emitted by the microsensors can be detected and fed to the downstream spectroscopic optics. By increasing the signal strength in this way, the time required to detect the emission spectrum of the microsensor under investigation can be significantly reduced, so that even fast-flowing microsensors can be detected with sufficient signal strength and evaluated accurately.

The particle of the microresonator can have a diameter in the range from 1 μm to 20, preferably 2 μm to 15 μm, particularly preferably 4 μm to 10 μm. The adsorbate layer can have a thickness in the range from 0.5 nm to 30 nm, preferably 1 nm to 20 nm, particularly preferably 1.5 nm to 10 nm, in particular 2 nm to 8 nm, whereby the thickness is understood to be a spatial expansion of the adsorbate layer in the radial direction from a center point of the microresonator.

The spectral analysis unit can be configured to perform the detection of the at least two optical resonance modes of the at least one microsensor only after the at least one microsensor has been contacted with a fluid that could contain an analyte. This embodiment has the advantage that the detection of the analyte can be carried out faster and more economically with the device.

The algorithmic unit may be configured to perform the determination of the optical thickness of the adsorbate layer according to a rigorous classical field theory.

Furthermore, the algorithmic unit may be configured to determine an optical thickness of the adsorbate layer of the at least one microsensor from spectral positions of the at least two detected resonant modes and at least one further parameter selected from the group consisting of relative amplitudes of the at least two detected resonant modes and linewidths of the at least two detected resonant modes via numerical algorithms.

Apart from this, the algorithmic unit can be configured to determine a further parameter of the at least one microsensor from spectral positions of the at least two detected resonance modes, and preferably from at least one further parameter selected from the group consisting of relative amplitudes of the at least two detected resonance modes and line widths of the at least two detected resonance modes, using numerical algorithms. The further parameter is preferably selected from the group consisting of the diameter of the at least one microsensor, the refractive index of the at least one microsensor, the refractive index of the adsorbate layer of the at least one microsensor and combinations thereof.

In addition, the algorithmic unit can be configured to determine a parameter of a fluid, preferably an optical property of a fluid, from spectral positions of the at least two detected resonant modes, and preferably from at least one further parameter selected from the group consisting of relative amplitudes of the at least two detected resonant modes and line widths of the at least two detected resonant modes, using numerical algorithms.

The at least one microsensor is preferably designed as an essentially spherical particle.

The fluorescent marker of the microresonator can be arranged in an inner space of the microresonator or on an outer surface of the microresonator.

The spectral analysis unit may be configured to perform the detection of at least two optical resonant modes of the at least one microsensor by detecting light scattered by the at least one microsensor and/or emitted by the at least one microsensor.

The container of the device may further contain a fluid that may contain an analyte. The container is optionally a fluid channel.

The at least one microsensor can be freely movable in the container, optionally in a fluid channel of the device. This embodiment is advantageous because the analyte can be detected more quickly and economically. Alternatively, the at least one microsensor may be present fixed in a fluid channel of the device, in particular fixed to an inner surface of a fluid channel of the device, wherein the fluid channel is particularly suitable for supplying the at least one microsensor to a fluid to be analyzed, which could contain an analyte.

The spectral analysis unit can be configured to repeat the detection of at least two optical resonance modes of the at least one microsensor at least once, optionally several times, wherein the algorithmic unit is configured to calculate a time course of the optical thickness of the adsorbate layer of the at least one microsensor from spectral positions of the at least two detected resonance modes, and preferably from at least one further parameter selected from the group consisting of relative amplitudes of the at least two detected resonance modes and linewidths of the at least two detected resonance modes, using numerical algorithms. This embodiment has the advantage that the binding kinetics of an analyte to the microsensor can be detected.

Furthermore, the spectral analysis unit may be configured to repeat the detection of at least two optical resonance modes of the at least one microsensor at least once, optionally several times, wherein the algorithmic unit is configured to determine a time course of at least one further parameter of the at least one microsensor from spectral positions of the detected resonance modes, and preferably from at least one further parameter selected from the group consisting of relative amplitudes of the at least two detected resonance modes and linewidths of the at least two detected resonance modes, via numerical algorithms, wherein the at least one further parameter which is selected from the group consisting of relative amplitudes of the at least two detected resonance modes and linewidths of the at least two detected resonance modes, using numerical algorithms, wherein the at least one further parameter is particularly preferably selected from the group consisting of diameter of the at least one microsensor, refractive index of the at least one microsensor, refractive index of the adsorbate layer of the at least one microsensor, refractive index of the fluid and combinations thereof. The advantage of this embodiment is that a time course of other parameters of the at least one microsensor or the fluid of the analyte can also be recorded.

The device can contain a fluid channel. The fluid channel preferably includes a supply line which is suitable for supplying the at least one microsensor to the fluid channel. Furthermore, the fluid channel preferably comprises an outlet suitable for discharging the at least one microsensor from the fluid channel, wherein the outlet preferably comprises a separator for the at least one microsensor.

The fluid channel can have at least one transparent wall, at least in some areas, which is transparent to light with a wavelength in the range of the emission wavelength of the fluorescent marker, wherein a detection optic is preferably arranged between the transparent wall and the spectral analysis unit and a concave reflector is particularly preferably arranged on a side of the container opposite the transparent wall.

Furthermore, the fluid channel can have at least one transparent wall, at least in certain areas, which is transparent to light with a wavelength in the range of the excitation wavelength of the fluorescent marker.

Apart from this, the fluid channel can have at least one transparent wall, at least in some areas, which is transparent to light with a wavelength in the range of the excitation wavelength and the emission wavelength of the fluorescent marker, wherein a detection optic with a coupling element for the light of the light source is arranged between the transparent wall and the spectral analysis unit, wherein the coupling element is reflective for light with a wavelength in the range of the excitation wavelength of the fluorescence marker and is transmissive for light with a wavelength in the range of the emission wavelength of the fluorescence marker.

In addition, the fluid channel can have at least one transparent wall, at least in certain areas, which is permeable to light with a wavelength in the range of the emission wavelength of the fluorescent marker and which enables the implementation of additional sensor technology, preferably a photodetector.

The algorithmic unit and the analysis unit, preferably the spectral analysis unit, the algorithmic unit and the analysis unit, can be designed as a single unit, preferably monolithically.

The microresonator used in the method and/or device may comprise or consist of a material selected from the group consisting of polymers, preferably selected from the group consisting of polystyrene, melamine resin, polydivinylbenzene, polymethyl methacrylate, poly(styrene-co-divinylbenzene), poly(styrene-co-methyl methacrylate) or polydimethylsilane. The microresonator used in the method and/or device may also comprise or consist of a material selected from the group consisting of inorganic materials, preferably selected from the group of inorganic dielectric materials, such as silica (SiO2) or titanium dioxide.

The adsorbate layer of the microresonator used in the method and/or the device may contain or consist of a material selected from the group consisting of dielectric materials, in particular organic materials, such as oligomers, polymers, peptides, proteins, oligonucleotides, DNA or cell components as well as mixtures or compounds of these materials. Furthermore, metals, semiconductors or metamaterials or combinations or compounds thereof can be used, provided that they do not lead to such a strong attenuation of the resonance modes that they are no longer detectable.

Furthermore, the adsorbate layer of the microresonator used in the method and/or device may comprise or consist of a material having a refractive index in the range of 1.43 to 1.47.

In addition, the adsorbate layer of the microresonator used in the method and/or device may be bound to the microresonator via non-covalent interactions (e.g. via ionic interactions, dipole-dipole interactions, van der Waals interactions and/or hydrogen bonds). Furthermore, the adsorbate layer can alternatively or additionally be bound to the microresonator via covalent bonds (i.e. a chemical coupling). The type of chemical coupling and thus the choice of molecules used for coupling depends on the surface of the microresonator and the functional groups available there.

Apart from this, the adsorbate layer of the microresonator used in the method and/or device may be divided into several sub-layers. The algorithmic unit may be configured to characterize the adsorbate layer as a uniform layer with a mean optical refractive index, depending on the physical model and contrast of different optical refractive indices of individual sublayers of the adsorbate layer with respect to each other (A. L. Aden & M. Kerker, Scattering of electromagnetic waves from two concentric spheres, Journal of Applied Physics, 1951, Vol. 22, pages 1242-1246), or as a composite layer with different optical refractive indices (R. Bhandari, Scattering coefficients for a multilayered sphere: analytic expressions and algorithms, Applied Optics, 1985, Vol. 24, pages 1960-1967).

The following figures and examples are intended to explain the object according to the invention in more detail, without wishing to limit it to the specific embodiments shown here.

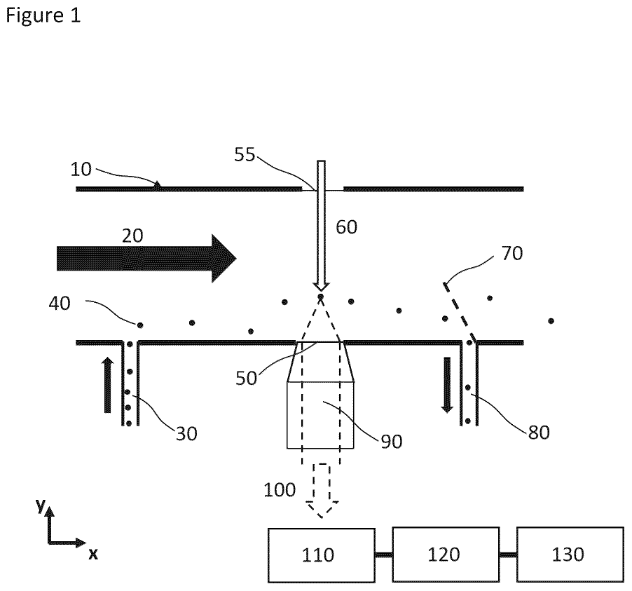

FIG. 1 schematically shows a device according to the invention with different transparent walls 50, 55 in a vessel (here: a microchannel) for excitation of the microsensors 40 with excitation light 60 and readout of fluorescent light 100 of the microsensors 40. A fluid 20 moves in a flow channel 10, which is to be tested for the presence and concentration of desired analytes by adding WGM-based microsensors 40 via a dosing system 30. The microsensors 40 flow over a certain distance with the fluid and can be fluorescently excited through a transparent wall 55 with the aid of excitation light 60. The fluorescence emission 100 is guided via the further transparent wall 50 and the subsequent detection optics 90 into the spectral analysis unit 110. Here the light is read out spectroscopically. As the flow progresses, the microsensors 40 can optionally be removed from the fluid again by a suitable capture device 70 in combination with an outlet 80. In the case of uncritical fluids, such as waste water, for example, the microsensors can also remain in the outflow of the fluid so that elements 70 and 80 are not required.

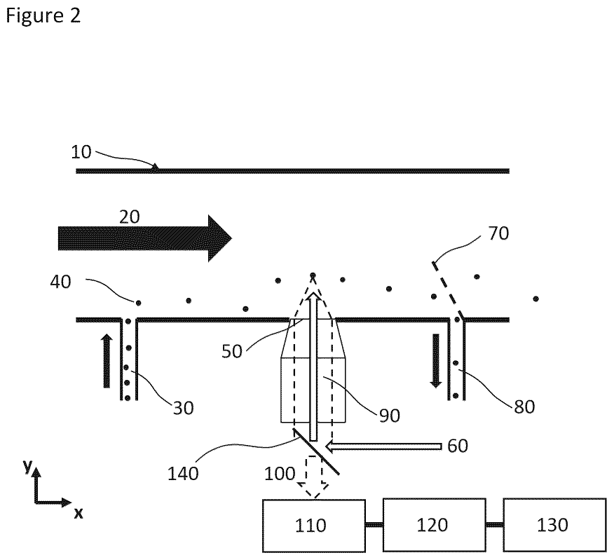

FIG. 2 schematically shows a further device according to the invention, which is designed similarly to FIG. 1, but has only a single transparent wall 50 for excitation of the microsensors 40 with excitation light 60 and readout of fluorescent light 100 from the microsensors 40.

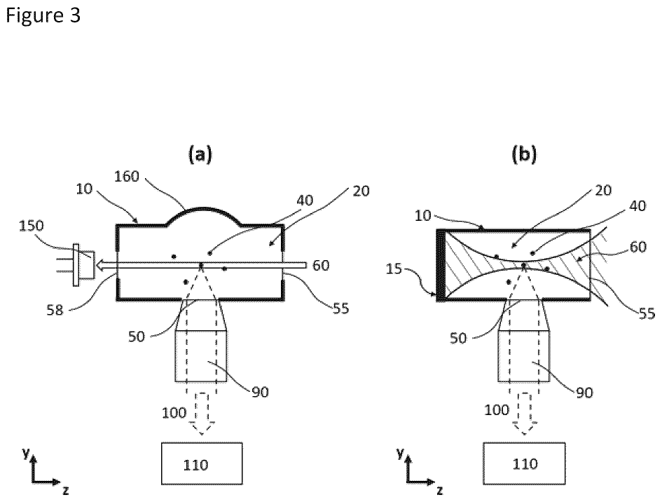

FIG. 3 schematically shows a further device according to the invention, which is designed similarly to FIG. 1, but has an alternative orientation of the excitation light 60 and a different beam shaping (collimated in FIG. 3a and focused in FIG. 3b).

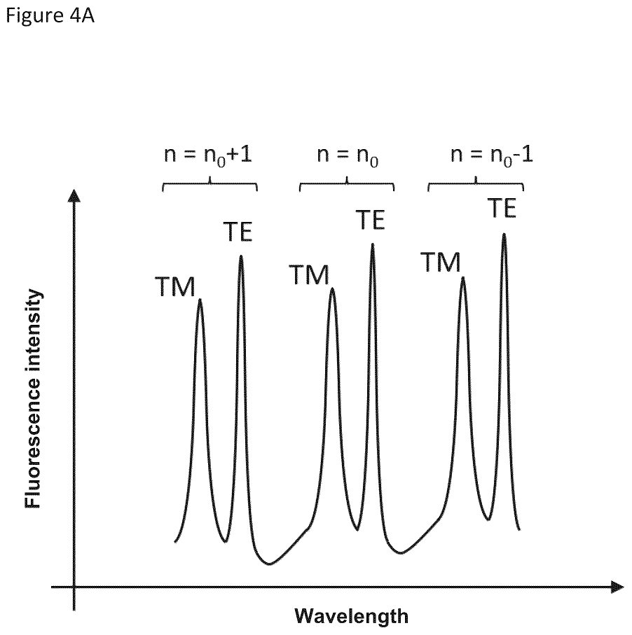

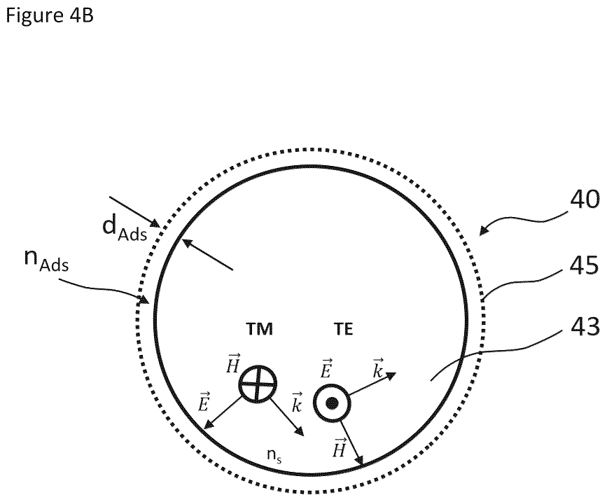

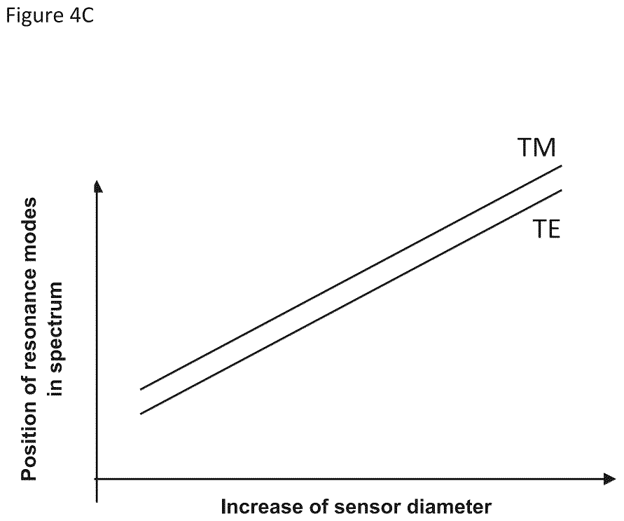

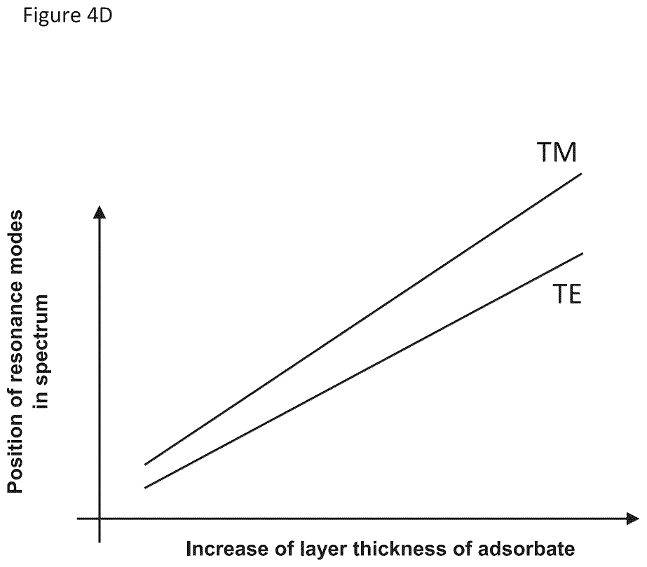

FIG. 4A shows an example of the fluorescence emission obtained from a microsensor as a function of wavelength, with the various resonance modes with different polarization states TM, TE being shown.

FIG. 4B schematically shows the structure of a microsensor 40, which consists of a microresonator 43 and an adsorbate layer 45.

FIG. 4C shows an example of the increase in the resonance modes TM, TE in the spectrum as a function of an increase in the diameter of the microsensor.

FIG. 4D shows an example of the increase in the resonance modes TM, TE in the spectrum of the microsensor as a function of an increase in the thickness of its adsorbate layer (due to the binding of analyte to the adsorbate layer).

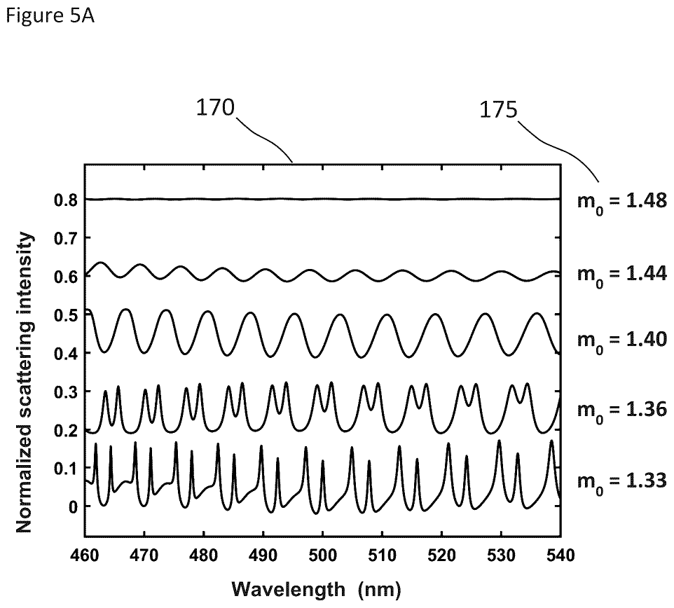

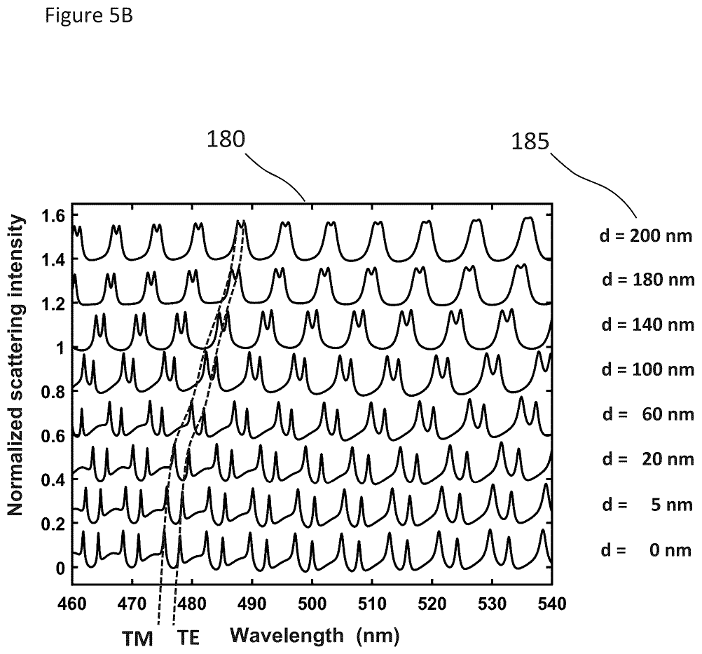

FIG. 5A shows exemplary simulations of WGM spectra 170 of a microresonator (i.e. dielectric microsensor) having a radius of R=3400 nm, an internal refractive index of 1.59 (approximately for polystyrene) and no adsorbate layer (i.e. The WGM spectra 170 in FIG. 5A were background-corrected and then normalized to their respective maximum before correction of the background.

FIG. 5B shows exemplary numerical simulations of WGM spectra 180 of a microresonator (i.e. dielectric microsensor) having a radius of R=3400 nm, an internal refractive index of 1.59 (approximately for polystyrene) and either no adsorbate layer (the layer thickness 185 of the adsorbate layer was set to 0 nm) or an adsorbate layer of certain layer thickness 185 (i.e. the layer thickness 185 of the adsorbate layer was set to 5 nm, 20 nm, 60 nm, 100 nm, 140 nm, 180 nm or 200 nm) in the microresonator surrounding medium. i.e. the layer thickness 185 of the adsorbate layer was set to 5 nm, 20 nm, 60 nm, 100 nm, 140 nm, 180 nm or 200 nm), in the medium surrounding the microresonator with a refractive index of 1.33. The adsorbate layer had a refractive index of m_{Ads}=1.48. The WGM spectra 180 in FIG. 5B were background-corrected and then normalized to their respective maximum before correction of the background.

### EXAMPLE 1—PRINCIPLE OF THE METHOD ACCORDING TO THE INVENTION

It is essential for the detection of an analyte in a fluid (the analysis sample) and thus of binding events on the surface of the microsensor to be able to determine a change in the thickness of the adsorbate layer on the microresonator, which occurs through the binding of the analyte in question.

In contrast to the particle size, the lot-to-lot scattering of the thickness of a specifically functionalized adsorbate layer is relatively small due to its low total thickness of typically a few to a few tens of nanometers and can therefore be easily distinguished from adsorption events on the surface of the microsensors within the evanescent field of the resonant modes with extensions of about 50-100 nm above the surface of the microresonator even without a statistical or direct reference. If the adsorbate layer thickness is known, it is possible to draw direct qualitative and quantitative conclusions about binding events without a reference.

The separation of the individual parameters, such as the size of the microresonator and the thickness of its adsorbate layer, can be achieved by their different influence on the mode position of the various resonance modes of the microsensor. In dielectric (i.e. non-conductive and non-absorbing or only slightly absorbing) microresonators, two different types of resonance modes with different orientations of the electric field are created (see FIG. 4B). In one case, the electric field of the modes is polarized in the radial direction, i.e. the simultaneously generated magnetic field is tangential to the particle surface (“transverse magnetic mode”, “TM” for short), in the other case the electric field is tangential to the particle surface and the magnetic field is in the radial direction (“transverse electric mode”, “TE” for short). Through these two fundamental types of resonant modes, the interface between the microsensor and its environment is fully captured and described by rigorous optical theories, such as the Mie theory for enveloped microparticles (A. L. Aden & M. Kerker, Scattering of electromagnetic waves from two concentric spheres, Journal of Applied Physics, 1951, Vol. 22, pages 1242-1246).

It is important for the separation of the individual parameters, such as the thickness of the adsorbate layer and the diameter of the microresonator, that TM and TE modes behave in a good approximation in the same way with regard to changes in the sensor size, while they shift differently with increasing thickness of the adsorbate layer (see FIGS. 4C and 4D). For example, TM modes for polystyrene-based microsensors in aqueous solution for the adsorption of biomolecules show a stronger shift than TE modes (see FIG. 4D). Thus, the separation of the size of the microresonator and the thickness of the adsorbate layer is unambiguously possible with the help of modern computing technology, for example by numerical modeling and fitting of Mie spectra to the measured data.

An example of a fluorescence spectrum obtained from a microsensor 40 is shown in FIG. 4A. The resonance modes of the microsensor 43 are superimposed on the fluorescence background of the dye and can be determined in spectral position, amplitude and line width by operations corresponding to the state of the art (such as by subtracting the background and numerically fitting theoretical resonance curves to the measured spectra). From these quantities characteristic of the respective microsensor (40) and its environment at the time of measurement, both the size of the sensor and the thickness of its adsorbate layer can be inferred, for example by numerical adaptation of suitable models, such as the Mie theory of the dielectric sphere surrounded by at least one sheath.

With the help of computer technology, it is therefore possible to draw conclusions about the system microresonator 43 together with the adsorbate layer 45 in the fluid 20 from the measured spectra in a very short time (typically within a few seconds) and to determine the parameters that are essential for the respective problem (such as sensor size, layer thickness and optical refractive index of the adsorbate as well as the optical refractive index of the environment). The individual parameters can be separated by their different influence on the mode position of the various resonance modes of the microsensor 40.

In addition to the Mie theory, there are other optical models for the excitation of resonant modes in spheres, such as the Debye theory or the Airy model, which is only an approximation but has the advantage that it can be represented analytically. As all these existing models describe the same physical system, they can be used in the same way as Mie theory to find the parameters mentioned.

### EXAMPLE 2—VARIANTS OF THE PROCESS OR DEVICE

FIGS. 1 and 2 show two different embodiments of the device according to the invention or the method according to the invention with regard to the fluorescence excitation of the microsensors 40.

In FIG. 1, the excitation light 60 is irradiated through a separate access window 55 into the fluid and thus onto at least one passing microsensor 40. The access window 55 can lie opposite the access window 50 used for detection or can be positioned in such a way that the at least one microsensor 40 located in the detection area is illuminated. An advantage of this arrangement is that the dielectric properties of the two access windows 50, 55 with respect to transmission, reflection and absorption can be adapted precisely to the respective radiation (fluorescence excitation or emission). At least one microsensor 40, which happens to pass the light cone, is fluorescently excited and can be spectrally analyzed through the access window 50. For this purpose, the detection optics 90 captures a portion of the fluorescent light 100 emitted by the at least one microsensor 40 and forwards it to a spectral analysis unit 110. The spectral profile of the fluorescence emission 100 of the microsensor 40 obtained by the spectral analysis unit 110 is subsequently analyzed by an algorithmic unit 120 with respect to characteristic variables, such as spectral position (optionally also relative amplitude and/or line width) of resonance modes of different polarization, and these results are then evaluated in an analysis unit 130 with respect to the presence and/or concentration of the analytes sought. The information thus obtained about a sought analyte is then made available by the device to the operator of the device via suitable interfaces.

In FIG. 2, however, the excitation of the fluorescence 100 of the at least one microsensor 40 takes place from the same side as the subsequent fluorescence detection through the access window 50. The detection optics 90 are additionally used to irradiate the excitation light 60 through the access window 50 into the fluid 20 via a coupling element 140. In this case, too, at least one microsensor 40, which flows in the fluid 20 and happens to pass the light cone of the excitation light 60, is excited to fluorescence 100 and, as described above, is read out via the detection optics 90 and analyzed with respect to the desired parameters with the aid of the units 110, 120, 130. It is important here that the coupling element 140 is transparent for the fluorescence emission 100 of the microsensor 40 captured by the detection optics 90, so that it can still reach the spectral analysis unit 110 (as in the case of FIG. 1). Higher demands are now also placed on the access window 50, since it must now not only be transparent for the fluorescence emission 100, but also for the excitation light 60. However, an advantage of this embodiment is that the wall of the flow channel 10 opposite the access window 50 can now be designed as a reflector 160 for the fluorescence emission 100 of the microsensor 40 (cf. FIG. 3a), so that the detection optics 90 can collect the fluorescent light over a larger solid angle, which in turn results in higher signal intensities, shorter measurement times and ultimately a larger range of possible flow velocities for the fluid.

FIGS. 1 and 2 show two basic embodiments of the invention, which can be modified in many ways. For example, FIG. 3 shows two different modifications.

In the embodiment shown in FIG. 3, the direction of flow of the fluid also corresponds to the x-axis in this figure. Here, the excitation light 60 is no longer guided along the optical axis of the detection optics 90, but is irradiated into the fluid 20 at a different angle. The angle of 90 degrees to the optical axis of the detection optics 90 shown here is just one example. FIGS. 3a and 3b also differ in the shape of the excitation light 60 used for fluorescence excitation 100. In FIG. 3a the excitation light 60 is collimated, in FIG. 3b it is focused on the focus of the detection optics 90. The latter embodiment has the advantage that only microsensors in the immediate vicinity of the focus of the detection optics 90 are significantly excited to fluorescence 100, so that potential interference signals from at least one microsensor 40, which is located at a position in the fluid 20 that is unsuitable for detection, are reduced. As mentioned above for FIG. 2, for the embodiments illustrated in FIG. 3, the channel wall opposite the access window 50 can also serve as a reflector 160 for increasing the signal of the fluorescent light of the at least one microsensor 40 collected by the detection optics 90.

Furthermore, FIG. 3a shows potentially useful additional sensor technology in the form of a further access window 58 and a photodetector 150 located behind it, which can be used for further characterization of the fluid 20, for example for turbidity measurements, which can provide information about the solids content of the fluid and thus support the analysis unit 130 in the interpretation of the measurement results. If there is no additional access window 58 in the beam path of the excitation light 60, as illustrated in FIG. 3b, the excitation light 60 can be modified, for example absorbed or reflected, via the rear wall 15 of the flow channel 10, either to suppress undesired effects, such as excitation of at least one microsensor 40 that is poorly positioned, or also to achieve desired effects, such as increasing the intensity of the excitation light 60 in the detection volume of the detection optics 90.

Depending on the fluid 20, its composition, its environment, its use or other influencing factors relevant for the analysis of the fluid 20, it may be that the microsensors cannot be introduced directly into the fluid, as shown in FIGS. 1-3, but that part of the fluid 20 must be separated from the flow channel 10 for the analysis. Even in these cases, however, it is always possible, after suitable separation or preparation of the part of the fluid 20 selected for analysis, to obtain a flow channel again which corresponds to FIGS. 1-3, so that the embodiments shown here are of sufficient general validity even in more complex applications of the microsensor technology presented here.

### EXAMPLE 3—ADVANTAGES OF THE METHOD ACCORDING TO THE INVENTION

The method according to the invention uses the determination of an optical thickness of the adsorbate layer of the at least one microsensor in a fluid potentially containing an analyte as well as its change, which occurs by binding the analyte sought, for measuring the presence of the analyte in the fluid. The advantages of using an optical thickness of the adsorbate layer over other possible parameters, such as the refractive index of the medium, m₀, in which the microsensor is located, will be explained below.

FIG. 5A shows numerical simulations of WGM spectra 170 of a microresonator (i.e. dielectric microsensor), which has a radius of R=3.4 μm, an internal refractive index of 1.59 (approximately for polystyrene) and no adsorbate layer (i.e. the layer thickness of the adsorbate layer was set to 0 nm), in media surrounding the microresonator with different refractive indices 175 in each case. The spectra 170 were calculated using Mie theory for a dielectric sphere embedded in a medium (according to Craig F. Bohren & Donald R. Huffman, Absorption and Scattering of Light by Small Particles, 1998, Wiley-VCH-Verlag, ISBN 9780471 293408, implemented in Matlab 2021b®), as is usual for the state of the art. For better comparability, the WGM spectra 170 were background corrected, i.e. the occurring long-wave beats were removed, since only the behavior of the WGM modes is of importance for the following. After correction of the background, the spectra were normalized to the respective original maximum, i.e. the maximum before correction of the background, in order to keep the respective WGM amplitudes comparable. The spectra 180 shown in FIG. 5B were processed analogously. The selected microresonator size of 6.8 μm in diameter is a value that has proven itself in practice as a compromise between the size of the resonator surface and the quality of the excitable WGMs. If the microresonator is larger, the relative area that an adsorbed analyte occupies on the microsensor surface decreases and the mode shift is correspondingly smaller. If the microresonator is smaller, the losses of the WGM excitation, for example due to surface scattering and radiation losses, increase, so that the individual WGMs are poorly characterized and therefore difficult to process.

FIG. 5A clearly shows that the line width of the WGM for this microresonator size increases rapidly with increasing refractive index 175 of the medium, m₀, and this leads to the fact that TM and TE modes begin to overlap even at values that are still below the refractive indices 175 to be expected for biological materials (as shown from about m₀=1.40), TM and TE modes begin to overlap, so that an experimental determination of m₀ in a quality required for the detection of (biological) analytes or adsorbates (such as bacteria as in U.S. Pat. No. 8,779,389 B2) becomes practically impossible. In practice, this means that there are limits to the use of the refractive index 175 of the medium, m₀, as an indicator for the detection of (biological) analytes or adsorbates: the mean refractive index 175 in the immediate vicinity of the microsensor, i.e. in the area of the evanescent field of the WGM, should remain below m_{eff}=1.40, which means that due to the higher values for the refractive index of the adsorbate of typically 1.43-1.48, only low surface coverages, i.e. small adsorbate concentrations, and also only low analyte concentrations in the medium (i.e. the fluid) are permitted.

In contrast, when using an optical thickness of the adsorbate layer of the at least one microsensor—as in the method and device according to the invention—any refractive indices for analyte and adsorbate layer are possible, i.e. any desired adsorbate concentrations can be measured on the surface of the microsensor up to complete coverage. This is illustrated in FIG. 5B. FIG. 5B shows numerical simulations of WGM spectra 180 of a microresonator (i.e. dielectric microsensor) that has a radius of 3.4 μm, an internal refractive index of 1.59 (approximately for polystyrene) and either no adsorbate layer (the layer thickness 185 of the adsorbate layer was set to 0 nm) or an adsorbate layer of certain layer thickness 185 (i.e. the layer thickness 185 of the adsorbate layer was set to 0 nm). i.e. the layer thickness 185 of the adsorbate layer was set to 5 nm, 20 nm, 60 nm, 100 nm, 140 nm, 180 nm or 200 nm), in the medium surrounding the microresonator with a refractive index of 1.33. The adsorbate layer had a refractive index of m_{Ads}=1.48. The simulations were carried out according to the theory for a coated sphere according to Bohren & Hofmann (Craig F. Bohren & Donald R. Huffman, Absorption and Scattering of Light by Small Particles, 1998, Wiley-VCH-Verlag, ISBN 9780471293408) and, as before, in Matlab 2021b®. Despite the high refractive index of the adsorbate layer of m_{Ads}=1.48, the WGMs are surprisingly still easily recognizable up to large layer thicknesses 185 of the adsorbate layer, which are often no longer relevant in practice, and above all TM and TE modes can be separated. With this differentiability, all relevant parameters, in particular the optical thickness of the adsorbate layer, can be determined on the basis of a rigorous theory in which all parameters have physical significance, as previously discussed for FIG. 4D, and in principle for any refractive indices of analyte and adsorbate layer. At the same time, it can be seen that neglecting an adsorbate layer on the microresonator in the simulation of scattering spectra based on Mie theory leads to different and possibly misleading results, since the change in the refractive index of the environment, m₀, always changes the entire environment of the microresonator and therefore only partial filling of the evanescent field around the microresonator cannot be described. Prior art methods and devices that do not take into account the adsorbate layer on the microreactor can therefore lead to incorrect results if the refractive index of the environment (e.g. the surrounding medium) changes.

Thus, the use of the optical thickness of the adsorbate layer is a more general and versatile parameter for the detection of analytes in the fluid. The method and device according to the invention are therefore more versatile and reliable than previous prior art methods and devices, i.e. can avoid a risk of false results due to a change in the refractive index of the environment of the microresonator.

### LIST OF REFERENCE SYMBOLS

10: Fluid channel (flow channel);
15: Wall of the fluid channel with special properties for absorbing or reflecting the excitation light;
20: Fluid in flow (e.g. aqueous solution in flow);
30: Supply line for at least one microsensor;
40: Microsensor;
43: Microresonator (i.e. particle containing or consisting of a dielectric material and a fluorescent marker);
45: Adsorbate layer;
50: Transparent wall fluid channel for fluorescence detection;
55: transparent wall in the fluid channel for fluorescence excitation);
58: Transparent wall in the fluid channel for implementing additional sensor technology, e.g. a photodetector;
60: Excitation light;
70: Separator for at least one microsensor;
80: Outlet for at least one microsensor;
90: Detection optics;
100: Fluorescent light from the at least one microsensor;
110: Spectral analysis unit;
120: Algorithmic unit;
130: Analysis unit;
140: Coupling element for the light from the light source (excitation light);
150: Photodetector;
160: Concave reflector;
170: WGM spectra of a microresonator without adsorbate layer in media with different refractive indices;
175: Refractive index of the medium surrounding the microresonator;
180: WGM spectra of a microresonator without or with an adsorbate layer in a medium with a refractive index of 1.33;
185: Layer thickness of the adsorbate layer.

1-18. (canceled)

19. A method for label-free detection of an analyte in a fluid, comprising:
(a) providing at least one dielectric microsensor in a container, the at least one microsensor comprising a microresonator and an adsorbate layer applied to the microresonator for binding an analyte, wherein the microresonator consists of a particle, a dielectric material, and a fluorescent marker, the microresonator having a greater optical refractive index than the optical refractive index of a fluid to be analyzed, wherein the microresonator is suitable for allowing more than one resonance mode to be expressed in an interior of the microresonator when a fluorescence of the fluorescence marker is excited;
(b) contacting the at least one microsensor with a fluid to be analyzed that could contain an analyte;
(c) irradiating light onto the at least one microsensor in the fluid, the light having a wavelength suitable for exciting the fluorescent marker of the at least one microsensor to fluoresce;
(d) detecting at least two optical resonance modes of the at least one microsensor from a detected fluorescent light of the at least one microsensor;
(e) determining an optical thickness of the adsorbate layer of the at least one microsensor in the fluid from spectral positions of the at least two detected resonance modes via numerical algorithms; and
(f) determining, based on the previously determined optical thickness of the adsorbate layer of the at least one microsensor, the extent to which an analyte in the fluid has bound to the at least one microsensor.

20. The method according to claim 19, wherein the particle of the microresonator has a diameter in the range from 1 μm to 20 μm, and/or the adsorbate layer has a thickness in the range from 0.5 nm to 30 nm, wherein the thickness refers to a spatial extension of the adsorbate layer in the radial direction from a center point of the microresonator.

21. The method according to claim 19, wherein no step of determining an optical thickness of the adsorbate layer of the at least one microsensor is carried out in the method before step b).

22. The method according to claim 19, wherein the optical thickness of the adsorbate layer is determined from spectral positions of the at least two detected resonance modes and at least one further parameter, which is selected from the group consisting of relative amplitudes of the at least two detected resonance modes and line widths of the at least two detected resonance modes, by utilizing numerical algorithms.

23. The method according to claim 19, wherein, furthermore
(i) from spectral positions of the at least two detected resonance modes, a further parameter of the at least one microsensor is determined by utilizing numerical algorithms, and/or
(ii) from spectral positions of the at least two detected resonance modes, a parameter of the fluid is determined by utilizing numerical algorithms.

24. The method according to claim 19, wherein the at least one microsensor
is freely movable; or
is fixed.

25. The method according to claim 19, wherein the detection of at least two optical resonance modes of the at least one microsensor is repeated at least once, optionally several times, in order to obtain a time course of the optical thickness of the adsorbate layer of the at least one microsensor from spectral positions of the at least two detected resonance modes.

26. The method according to claim 25, wherein the time course of the optical thickness of the adsorbate layer of the at least one microsensor from spectral positions of the at least two detected resonance modes is obtained from at least one further parameter selected from the group consisting of relative amplitudes of the at least two detected resonance modes and linewidths of the at least two detected resonance modes, by utilizing numerical algorithms, wherein optionally a time course of at least one further parameter of the at least one microsensor is determined from spectral positions of the at least two detected resonance modes.

27. A device for the label-free detection of an analyte in a fluid, comprising:
(a) a container containing at least one dielectric microsensor, at least one microsensor comprising a microresonator and an adsorbate layer applied to the microresonator for binding an analyte, wherein the microresonator consists of a particle containing a dielectric material and a fluorescent marker, the microresonator having a greater optical refractive index than the optical refractive index of a fluid to be analyzed, wherein the microresonator is suitable for allowing more than one resonance mode to be expressed in an interior of the microresonator when a fluorescence of the fluorescence marker is excited;
(b) a light source for irradiating light onto the at least one microsensor, the light having a wavelength which is suitable for exciting the fluorescent marker of the at least one microsensor to fluoresce,
(c) a spectral analysis unit configured to detect at least two optical resonance modes of the at least one microsensor from a detected fluorescent light;
(d) an algorithmic unit configured to determine an optical thickness of the adsorbate layer of the at least one microsensor from spectral positions of the at least two detected resonance modes via numerical algorithms; and
(e) an analysis unit which is configured to determine, based on the determined optical thickness of the adsorbate layer of the at least one microsensor, the extent to which an analyte has bound to the at least one microsensor.

28. The device according to claim 27, wherein the particle of the microresonator has a diameter in the range from 1 μm to 20 μm and/or the adsorbate layer has a thickness in the range from 0.5 nm to 30 nm, wherein thickness refers to mean a spatial extension of the adsorbate layer in the radial direction from a center point of the microresonator.

29. The device according to claim 27, wherein the spectral analysis unit is configured to perform the detection of the at least two optical resonance modes of the at least one microsensor only after the at least one microsensor has been contacted with a fluid that may contain an analyte.

30. The device according to claim 27, wherein the algorithmic unit is configured to determine an optical thickness of the adsorbate layer of the at least one microsensor from spectral positions of the at least two detected resonance modes and at least one further parameter selected from the group consisting of relative amplitudes of the at least two detected resonance modes and line widths of the at least two detected resonance modes via numerical algorithms.

31. The device according to claim 27, wherein the algorithmic unit is configured
(i) to determine a further parameter of the at least one microsensor from spectral positions of the at least two detected resonance modes, and/or
(ii) to determine a parameter of a fluid.

32. The device according to claim 27, wherein the container further contains a fluid that could contain an analyte, wherein the container is optionally a fluid channel.

33. The device according to claim 27, wherein the at least one microsensor
(i) is freely movable in the container, optionally in a fluid channel of the device; or
(ii) is fixed in a fluid channel of the device.

34. The device according to claim 28, wherein the spectral analysis unit is configured to repeat the detection of at least two optical resonance modes of the at least one microsensor at least once, optionally several times, and the algorithmic unit is configured to calculate a time course of the optical thickness of the adsorbate layer of the at least one microsensor from spectral positions of the at least two detected resonance modes.

35. The device according to claim 28, wherein the device comprises a fluid channel.

36. The device according to claim 35, wherein the fluid channel (i) contains a supply line which is suitable for supplying the at least one microsensor to the fluid channel; and/or (ii) contains an outlet which is suitable for discharging the at least one microsensor from the fluid channel, the outlet preferably having a separator for the at least one microsensor.

37. The device according to claim 35, wherein the fluid channel has at least one transparent wall, at least in some regions, which is transparent to light with a wavelength in the range
(i) of the emission wavelength of the fluorescent marker,
(ii) of the excitation wavelength of the fluorescent marker; and/or
(iii) of the excitation wavelength and the emission wavelength of the fluorescent marker, wherein a detection optics with a coupling element for the light of the light source is arranged between the transparent wall and the spectral analysis unit, wherein the coupling element is reflective for light with a wavelength in the range of the excitation wavelength of the fluorescent marker and is transmissive for light with a wavelength in the range of the emission wavelength of the fluorescent marker; and/or
(iv) of the emission wavelength of the fluorescent marker and which enables the implementation of additional sensor technology.

38. The device according to claim 27, wherein the algorithmic unit and the analysis unit are designed as a single unit.
